(19) United States
(12) Patent Application Publication
(10) Pub. No.: US 2021/0135379 A1
(43) Pub. Date: May 6, 2021

(54) TERMINAL-EQUIPPED ELECTRIC WIRE PRODUCTION METHOD AND TERMINAL-EQUIPPED ELECTRIC WIRE

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventors: Taiji Mochizuki, Mie (JP); Kenji Miyamoto, Mie (JP); Kazuhiro Washio, Mie (JP); Naoya Nishimura, Mie (JP)

(21) Appl. No.: 16/491,792

(22) PCT Filed: Mar. 1, 2018
(86) PCT No.: PCT/JP2018/007827

§ 371 Date: Sep. 6, 2019

(30) Foreign Application Priority Data
Mar. 17, 2017 (JP) 2017-052523

(51) Int. Cl. H01R 4/18; H01R 43/048; H01R 11/11; H01R 4/20

(52) U.S. Cl. CPC H01R 4/184; H01R 4/20; H01R 11/11; H01R 43/048

(57) ABSTRACT

Provided is a technique for easily manufacturing a terminal-equipped electrical wire in which a part of a core wire crimping portion is highly compressed. A method of manufacturing the terminal-equipped electrical wire includes the following steps (a) to (c). A step (a) is a step of preparing a terminal fitting including a core wire crimping portion having a bottom portion and a pair of crimping pieces (34, 34) standing upright on the bottom portion, and a partially overlapping portion (37) overlaid, so as to protrude, on the outside of a partial region of the bottom portion of the core wire crimping portion along an extending direction of the bottom portion. A step (b) is a step of accommodating core wire exposed portions (22) of electrical wires in the core wire crimping portion. A step (c) is a step of crimping the core wire crimping portion to the core wire exposed portions (22).

### TECHNICAL FIELD

The present invention relates to a terminal-equipped electrical wire.

### BACKGROUND

Patent Document 1 discloses a terminal fitting crimped to an electrical wire. The terminal fitting disclosed in Patent document 1 has a configuration in which a second barrel portion is provided inside a pair of normal core wire crimping barrels. Here, the second barrel portion overlaps on a partial region along the axial direction of the electrical wire with respect to the pair of barrels. With this configuration, in the core wire crimping portion, two portions having different compression rates along the axial direction of the electrical wire can be arranged. As a result, it is said that the mechanical strength of the terminal-equipped electrical wire can be ensured, and, at the same time, the electrical resistance between the electrical wire and the terminal fitting can be reduced.

### PRIOR ART DOCUMENT

### Patent Document

Patent Document 1: JP 2013-114908A

### SUMMARY OF THE INVENTION

### Problems to be Solved

However, the terminal fitting disclosed in Patent Document 1 has a configuration in which the second barrel portion is newly provided inside a pair of normal core wire crimping barrels. As a result, in the portion where the second barrel portion is provided, the space surrounded by the pair of barrels and the bottom portion becomes narrow. For this reason, if an attempt is made to set dimensions such as the barrel length in the pair of barrels with reference to the conventional terminal fitting having no second barrel portion, studies need to be carried out, which may require time and effort.

Therefore, it is an object of the present invention to provide a technique for easily manufacturing a terminal-equipped electrical wire in which a part of a core wire crimping portion is highly compressed.

### Means to Solve the Problem

In order to solve the above issues, a method of manufacturing a terminal-equipped electrical wire according to a first aspect includes the steps of: (a) preparing a terminal fitting including a core wire crimping portion having a bottom portion and a pair of crimping pieces standing upright on the bottom portion, and a partially overlapping portion overlaid, so as to protrude, on the outside of a partial region of the bottom portion of the core wire crimping portion along an extending direction of the bottom portion; (b) accommodating core wire exposed portions of electrical wires in the core wire crimping portion; and (c) crimping the core wire crimping portion to the core wire exposed portions.

A method of manufacturing the terminal-equipped electrical wire according to a second aspect is the method of manufacturing the terminal-equipped electrical wire according to the first aspect, wherein, in the step (b), the core wire exposed portion of a first electrical wire and the core wire exposed portion of a second electrical wire are accommodated in the same core wire crimping portion.

A method of manufacturing the terminal-equipped electrical wire according to a third aspect is the method of manufacturing the terminal-equipped electrical wire according to the first or second aspect, wherein the partially overlapping portion is formed by bending a part of a plate material constituting the core wire crimping portion.

A terminal-equipped electrical wire according to a fourth aspect includes: electrical wires that each include a core wire and an insulating coating covering the core wire, and in which a core wire exposed portion where the core wire is exposed is formed in a partial region along the longitudinal direction; and a terminal fitting that includes a core wire crimping portion having a bottom portion and a pair of crimping pieces standing upright on the bottom portion, and crimped to the core wire exposed portions, and a partially overlapping portion overlaid on the outside of a partial region of the bottom portion of the core wire crimping portion along the extending direction of the bottom portion, and in which a portion of the core wire crimping portion that overlaps the partially overlapping portion protrudes to the core wire exposed portions side.

A terminal-equipped electrical wire according to a fifth aspect is the terminal-equipped electrical wire according to the fourth aspect, wherein the same terminal fitting is crimped to a region in which the core wire exposed portion of a first electrical wire and the core wire exposed portion of a second electrical wire overlap.

A terminal-equipped electrical wire according to a sixth aspect is the terminal-equipped electrical wire according to the fourth or fifth aspect, wherein the partially overlapping portion is formed by bending a part of a plate material constituting the core wire crimping portion.

### Effect of the Invention

According to the first to third aspects, because the partially overlapping portion is overlaid on the outside of the core wire crimping portion, the high compression portion can be easily formed without reducing the core wire arrangement space in the core wire crimping portion before crimping. Accordingly, it is possible to easily manufacture a terminal-equipped electrical wire in which a part of the core wire crimping portion is highly compressed.

In particular, according to the second aspect, a splice structure in which electrical wires are connected via one crimp terminal can be easily manufactured.

In particular, according to the third aspect, a terminal fitting provided with a core wire crimping portion and a partially overlapping portion can be manufactured from one plate material.

According to the fourth to sixth aspects, because the partially overlapping portion is overlaid on the outside of the core wire crimping portion, the dimensions of the core wire crimping portion can be easily set based on the conventional one having no partially overlapping portion. With this configuration, it is possible to easily manufacture a terminal-equipped electrical wire in which a part of the core wire crimping portion is highly compressed.

In particular, according to the fifth aspect, a splice structure in which electrical wires are connected via one crimp terminal can be easily manufactured.

In particular, according to the sixth aspect, it is possible to manufacture a terminal fitting provided with a core wire crimping portion and a partially overlapping portion from one plate material.

### BRIEF DESCRIPTION OF THE DRAWINGS

FIG. 1 is a perspective view showing a terminal fitting according to an embodiment.

FIG. 2 is an elevation view showing the terminal fitting according to the embodiment.

FIG. 3 is a developed view of the terminal fitting according to the embodiment.

FIG. 4 is a plan view showing a state in which core wire exposed portions are accommodated in the terminal fitting.

FIG. 5 is a side view showing a state in which the terminal fitting is crimped to the core wire exposed portions.

FIG. 6 is a plan view showing a state in which the terminal fitting is crimped to the core wire exposed portions.

FIG. 7 is a plan view showing a state in which the terminal fitting is crimped to the core wire exposed portions.

FIG. 8 is a plan view showing a state in which the terminal fitting is crimped to the core wire exposed portions.

FIG. 9 is a plan view showing a terminal-equipped electrical wire.

FIG. 10 is a side view showing the terminal-equipped electrical wire.

FIG. 11 is a cross-sectional view taken along the line XI-XI of FIG. 9.

FIG. 12 is a cross-sectional view taken along the line XII-XII of FIG. 10.

FIG. 13 is a cross-sectional view taken along the line XIII-XIII of FIG. 10.

FIG. 14 is a perspective view showing a first variation of the terminal fitting according to the embodiment.

FIG. 15 is a developed view of the terminal fitting according to the first variation.

FIG. 16 is a perspective view showing a second variation of the terminal fitting according to the embodiment.

FIG. 17 is a developed view of the terminal fitting according to the second variation.

FIG. 18 is a perspective view showing a third variation of the terminal fitting according to the embodiment.

FIG. 19 is a developed view of the terminal fitting according to the third variation.

### DETAILED DESCRIPTION TO EXECUTE THE INVENTION

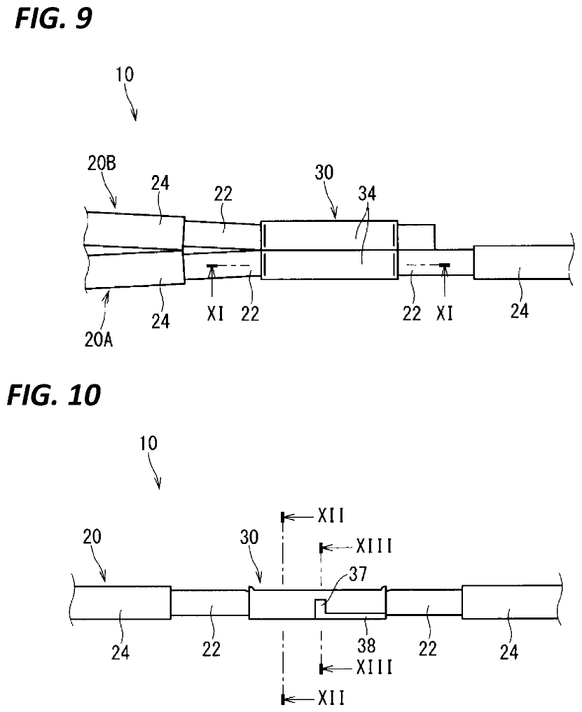

Hereinafter, a terminal-equipped electrical wire according to embodiments and the method of manufacturing the same will be described. A terminal-equipped electrical wire 10 has a configuration in which a terminal fitting 30 is crimped to core wire exposed portions of electrical wires 20 (see FIG. 9). At this time, at the crimped portion between the terminal fitting 30 and a core wire 22, two portions of the core wire 22 having different compression ratios are formed aligned along the axial direction of the electrical wire 20. With this configuration, the mechanical strength of the terminal-equipped electrical wire 10 can be ensured, and, at the same time, the electrical resistance between the electrical wires 20 and the terminal fitting 30 can be reduced.

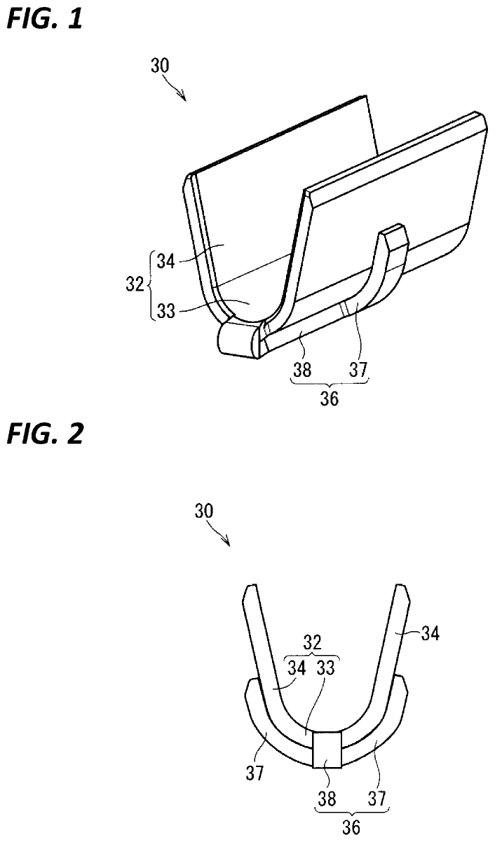

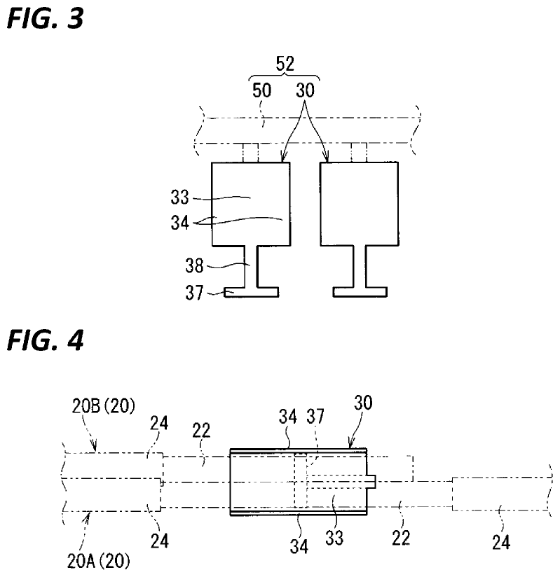

Here, the terminal fitting 30 will be described with reference to FIGS. 1 to 3. FIG. 1 is a perspective view showing the terminal fitting 30 according to the embodiment. FIG. 2 is an elevation view showing the terminal fitting 30 according to the embodiment. FIG. 3 is a developed view of the terminal fitting 30 according to the embodiment.

The terminal fitting 30 is made of any metal material such as copper or copper alloy. The terminal fitting 30 may also be plated with any metal such as tin or nickel. The terminal fitting 30 is formed by pressing a metal plate material into a predetermined shape and then bending it. At this time, in the example shown in FIG. 3, the terminal fitting 30 is described as being separated and provided one by one from a so-called continuous terminal 52 configured by connecting a plurality of terminal fittings 30 to a strip portion 50, but the present invention is not limited to this. Note that it is conceivable that the separation of the terminal fitting 30 from the strip portion 50 is performed at the same time as the crimping, for example.

The terminal fitting 30 includes a core wire crimping portion 32 and a partially overlapping portion 36. Here, as shown in FIG. 3, it is assumed that one plate material constituting the core wire crimping portion 32 is bent, and the partially overlapping portion 36 is also provided.

In addition, in this case, the terminal fitting 30 is an example of a member for connecting a plurality of electrical wires 20 crimped together at one time to the core wire crimping portion 32, that is, a member for so-called splice connection. For this reason, the terminal fitting 30 includes no mating connection portion. However, the terminal fitting 30 may also include a mating connection portion. The details of a terminal fitting 30 including a mating connection portion will be described later.

The core wire crimping portion 32 is a portion that is crimped to the core wire exposed portions. The core wire crimping portion 32 includes a bottom portion 33 and a pair of crimping pieces 34 standing upright on the bottom portion 33. As shown in FIG. 3, the core wire crimping portion 32 is obtained by bending a rectangular plate material.

The partially overlapping portion 36 is overlaid on the outside of a partial region of the bottom portion 33 of the core wire crimping portion 32 along the extending direction of the bottom portion 33. The partially overlapping portion 36 is pressed together with the core wire crimping portion 32 by an upper mold 82 and a lower mold 84 (see FIG. 6) of a terminal crimping machine 80. In this manner, the protrusion amount of the partially overlapping portion 36 with respect to the core wire crimping portion 32 is reduced, and the portion of the core wire crimping portion 32 that overlaps the partially overlapping portion 36 protrudes on the core wire exposed portions side. As a result, the portion of the core wire crimping portion 32 overlapping the partially overlapping portion 36 can compress the core wires 22 more than the portion not overlapping the partially overlapping portion 36.

Here, the partially overlapping portion 36 is formed by bending a metal plate material constituting the core wire crimping portion 32. Specifically, the partially overlapping portion 36 includes a high compression piece 37 and a connection piece 38.

The high compression piece 37 is a portion for forming a high compression portion in the core wire crimping portion 32. Here, in the elevation view shown in FIG. 2, the high compression piece 37 is formed in a shape along a region including the bottom portion 33 and the proximal end of the crimping pieces 34. However, the shape of the high compression piece 37 along the circumferential direction is not limited to the above-mentioned shape. For example, the shape of the high compression piece 37 along the circumferential direction may also be formed shorter or longer in the circumferential direction than the example shown in FIG. 2. Also, the shape of the high compression piece 37 along the circumferential direction may also be divided in the circumferential direction. At this time, it is preferable that the high compression piece 37 is formed inward of the end portion of each of the crimping pieces 34, along the width direction (left and right direction in FIG. 2) of the terminal fitting 30. In addition, it is preferable that the high compression piece 37 is formed so as to not be bent and deformed together with the crimping pieces 34 by the upper mold 82 of the crimping die that bends and deforms the crimping pieces 34.

Further, the high compression piece 37 is provided at the position of the middle portion (specifically, the center in this case) of the core wire crimping portion 32 along the longitudinal direction of the terminal fitting 30 (the normal direction to the sheet of FIG. 2), but the position of the high compression piece 37 is not limited to this position. The high compression piece 37 may also be provided at an end of the core wire crimping portion 32 along the longitudinal direction of the terminal fitting 30. Also, a plurality of high compression pieces 37 may also be provided at intervals along the longitudinal direction of the terminal fitting 30. The dimensions of the area in which the high compression piece 37 is provided along the longitudinal direction of the terminal fitting 30 and the dimensions of the area in which the high compression piece 37 is not provided are set as appropriate, in accordance with, for example, the composition ratio of the high compression portion and the low compression portion.

The connection piece 38 is a portion for connecting the high compression piece 37 and the core wire crimping portion 32. Here, the connection piece 38 is provided, by extending the partially overlapping portion 36 along the extending direction (the longitudinal direction of the terminal fitting 30) of the bottom portion 33 from the core wire crimping portion 32 in the developed view, and by providing the high compression piece 37 at the position of the middle portion of the core wire crimping portion 32 along the longitudinal direction of the terminal fitting 30. Accordingly, the connection piece 38 may not be provided depending on the shape, the position, and the like of the high compression piece 37. Here, the connection piece 38 extends from the bottom portion 33. The dimension of the connection piece 38 along the longitudinal direction of the terminal fitting 30 is set to about half of the length of the core wire crimping portion 32.

### Manufacturing Method

Next, a method of manufacturing the terminal-equipped electrical wire 10 by crimping the above terminal fitting 30 to the electrical wires 20 will be described.

First, the above terminal fitting 30 is prepared, which includes the core wire crimping portion 32 having the bottom portion 33 and the pair of crimping pieces 34 standing upright on the bottom portion 33, and the partially overlapping portion 36 overlaid, so as to protrude, on the outside of a partial region along the extending direction of the bottom portion 33 of the core wire crimping portion 32 (step (a)).

Then, the core wire exposed portions of the electrical wires 20 are accommodated in the core wire crimping portion 32 (step (b)). Specifically, as shown in FIG. 4, the core wire exposed portions are accommodated in the space surrounded by the bottom portion 33 and the pair of crimping pieces 34 of the core wire crimping portion 32. As mentioned above, here, the terminal fitting 30 is a member for splice connection. For this reason, in this case, core wire exposed portions of a plurality of electrical wires 20 (two in the example shown in FIG. 4) are accommodated in the above-mentioned space.

Here, each electrical wire 20 includes a core wire 22 and an insulating coating 24 covering the outer periphery of the core wire 22.

The core wire 22 is made of a material such as aluminum, an aluminum alloy, copper, a copper alloy, or the like. Here, the core wire 22 of at least one electrical wire 20 is made of a material such as aluminum, an aluminum alloy, or the like. The core wire 22 may be configured by one strand, or may also be configured by a plurality of strands. If the core wire 22 is configured by a plurality of strands, the strands may or may not be twisted together.

The insulating coating 24 is formed by extruding a resin such as polyethylene, polyvinyl chloride, or the like around the core wire 22.

Each electrical wire 20 is provided with a core wire exposed portion where the core wire 22 is exposed. Here, in the example shown in FIG. 4, the positions at which the core wire exposed portions are formed in the two electrical wires 20 are different. Specifically, the core wire exposed portion of a first electrical wire 20A of one of the two electrical wires 20 is formed at a longitudinal intermediate portion of the electrical wire 20. Also, the core wire exposed portion of a second electrical wire 20B of the other of the two electrical wires 20 is formed at a longitudinal end portion of the electrical wire 20. However, the positions where the core wire exposed portions are formed in the two electrical wires 20 may also be the same.

Then, the core wire crimping portion 32 is crimped to the core wire exposed portions (step (c)).

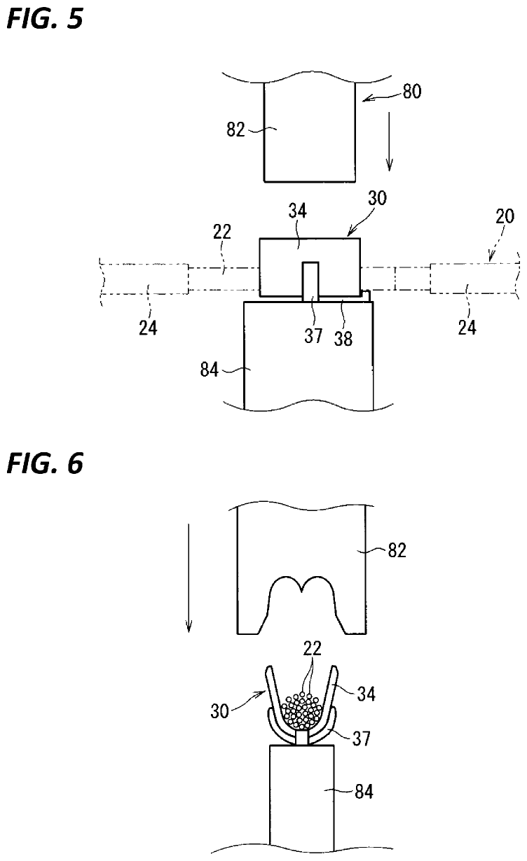

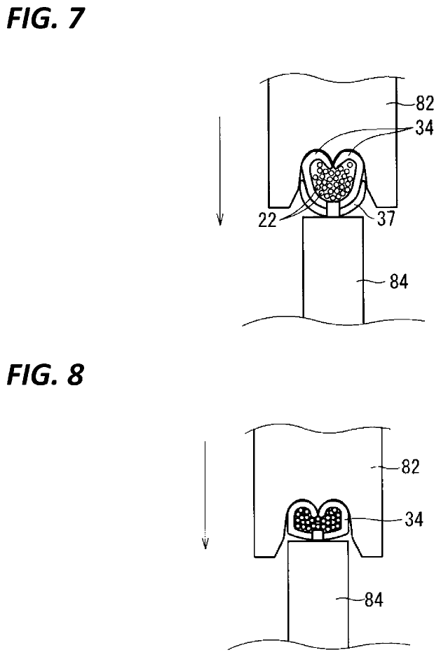

Specifically, as shown in FIGS. 5 and 6, the terminal fitting 30 is supported by the lower mold 84 of the terminal crimping machine 80, and the upper mold 82 and the lower mold 84 of the terminal crimping machine 80 are moved closer to each other in a state where the core wire exposed portions are accommodated in the terminal fitting 30. As shown in FIG. 7, as the upper mold 82 and the lower mold 84 are moved closer to each other, the upper mold 82 bends and deforms the crimping pieces 34. At this time, as shown in FIG. 7, it is preferable that the crimping pieces 34 are closed before the compression is started. Then, as shown in FIG. 8, in a state where the upper mold 82 and the lower mold 84 are closest to each other, the terminal fitting 30 and the core wire exposed portions are pressed in a desired shape, and the crimping is completed.

As a result, the terminal fitting 30 is crimped to the core wire exposed portions, and the terminal-equipped electrical wire 10 shown in FIGS. 9 and 10 is manufactured.

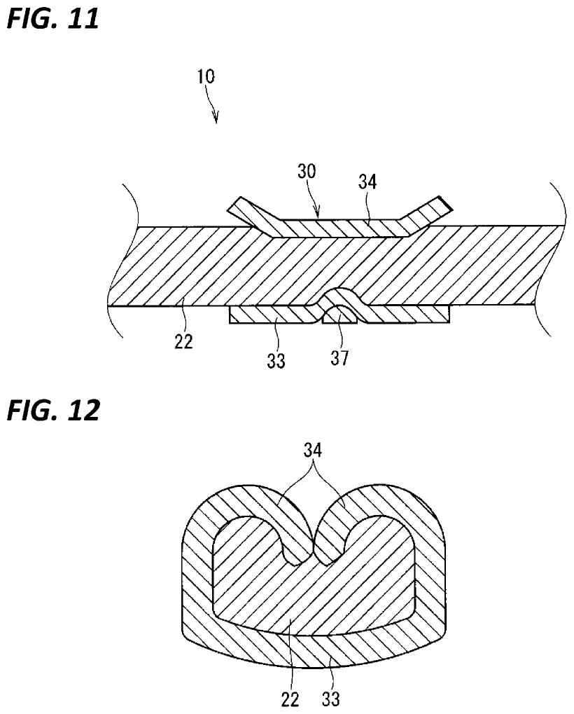

When the terminal-equipped electrical wire 10 is viewed, the amount by which the partially overlapping portion 36 protrudes outward with respect to the core wire crimping portion 32 is reduced by the press by the terminal crimping machine 80. Instead, as shown in the longitudinal sectional view of FIG. 11, the portion of the core wire crimping portion 32 overlapping the partially overlapping portion 36 is pressed against by the partially overlapping portion 36, and protrudes toward the core wire exposed portions side. As a result, as can be seen from FIG. 12, which is a cross-sectional view of the portion where no partially overlapping portion 36 is present, and FIG. 13, which is a cross-sectional view of the portion where the partially overlapping portion 36 is present, in the portion where the partially overlapping portion 36 is present, the core wire crimping portion 32 is compressed more highly than the portion where the partially overlapping portion 36 is not present. Accordingly, in the terminal-equipped electrical wire 10, the portion where the partially overlapping portion 36 is not present is a low compression portion, and the portion where the partially overlapping portion 36 is present is a high compression portion.

Specifically, in this case, the portion of the partially overlapping portion 36 where the high compression piece 37 is provided is the most compressed high compression portion, and the portion where the partially overlapping portion 36 is not provided is the least compressed low compression portion. The compression ratio (the cross-sectional area of the core wire after crimping/the cross-sectional area of the core wire before crimping) of the core wire 22 in the high compression portion and the low compression portion may be determined as appropriate. For example, the value may be set as follows. That is, the compression ratio of the core wire 22 in the high compression portion is, for example, 30 to 50% from the viewpoint of breaking the oxide film on the surface of the core wire 22 to reduce the electrical resistance and ensure good electrical performance On the other hand, the compression ratio of the core wire 22 in the low compression portion is, for example, 60 to 90% from the viewpoint of preventing breakage of the core wire 22 and ensuring good electrical wire (core wire) retention.

Note that, the portion of the partially overlapping portion 36 where the connection piece 38 is provided is a middle compression portion, which is compressed more than the low compression portion but is not compressed more than the high compression portion. In this case, the portion without the connection piece 38 may be located on the insulating coating 24 side, or the portion with the connection piece 38 may be located on the insulating coating 24 side, with respect to the second electrical wire 20B in which the core wire exposed portion is formed at the end of the electrical wire 20. Here, the portion without the connection piece 38 is located on the insulating coating 24 side with respect to the second electrical wire 20B.

According to the terminal-equipped electrical wire 10 and the method of manufacturing the same configured as described above, because the partially overlapping portion 36 is overlaid on the outside of the core wire crimping portion 32, the core wire arrangement space in the core wire crimping portion 32 before crimping is not reduced. Accordingly, the dimensions of the core wire crimping portion 32 can be easily set based on the conventional one having no partially overlapping portion 36, and the high compression portion can be easily provided. For this reason, a terminal-equipped electrical wire 10 in which a part of the core wire crimping portion 32 is highly compressed can be easily manufactured.

Also, a splice structure in which the electrical wires 20 are connected via one crimp terminal can be easily manufactured.

Also, a terminal fitting 30 provided with the core wire crimping portion 32 and the partially overlapping portion 36 can be easily manufactured from one plate material.

### Variations

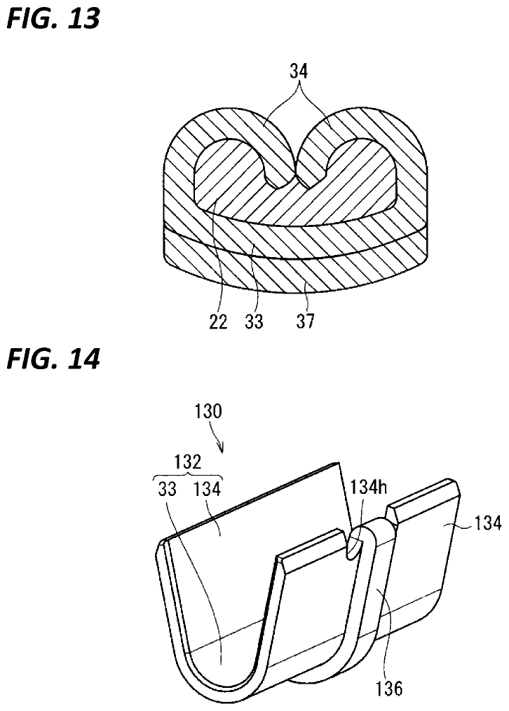

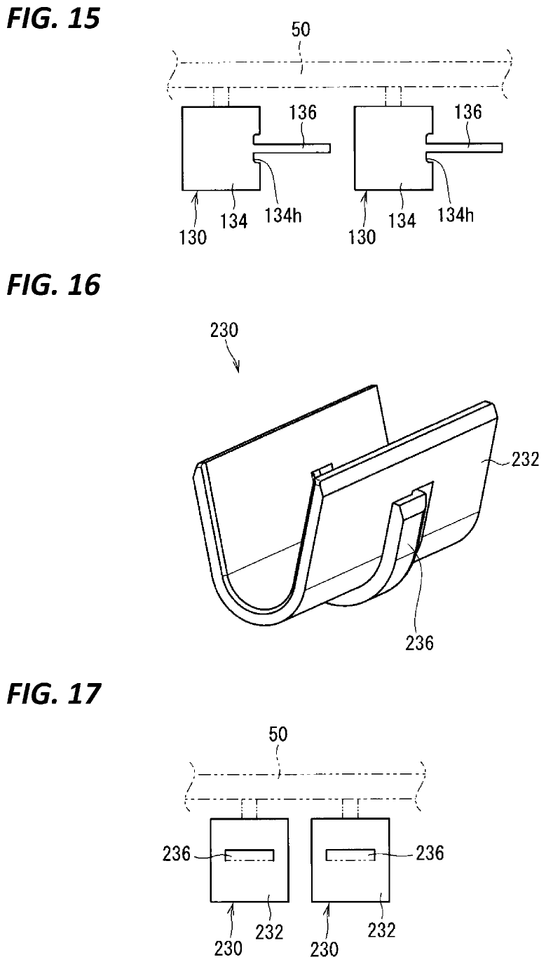

FIG. 14 is a perspective view showing a first variation of the terminal fitting 30 according to the embodiment. FIG. 15 is a developed view of a terminal fitting 130 according to the first variation.

In the terminal fitting 130 according to the first variation, the shape of a partially overlapping portion 136 is different from the shape of the partially overlapping portion 36 of the terminal fitting 30 according to the embodiment.

Specifically, the partially overlapping portion 136 is formed so as to extend from a core wire crimping portion 132 along the width direction of the terminal. Here, the partially overlapping portion 136 extends from the end portion of one of the crimping pieces 134. At this time, a recessed portion 134h recessed toward the proximal end side is formed at the end portion of the crimping piece 134. With this configuration, the partially overlapping portion 136 is set, including its folding margin, so as to not protrude in the height direction more than the crimping pieces 134. Note that, only one partially overlapping portion 136 is formed in such a manner as to extend only from the end portion of one of the crimping pieces 134, but two partially overlapping portions 136 may also be formed in such a manner as to extend from the end portions of both crimping pieces 134.

Even in the case where the terminal fitting 130 is crimped to the core wire exposed portions, the portion where the partially overlapping portion 136 is present can be a high compression portion compared with the portion where the partially overlapping portion 136 is not present. Also, the terminal fitting 130 can be manufactured from one metal plate material.

Note that, in the example shown in FIG. 14, the partially overlapping portion 136 is bent and deformed together with the crimping pieces 134 by the upper mold 82.

FIG. 16 is a perspective view showing a second variation of the terminal fitting 30 according to the embodiment. FIG. 17 is a developed view of a terminal fitting 230 according to the second variation.

In the terminal fitting 230 according to the second variation, the shape of a partially overlapping portion 236 is different from the shape of the partially overlapping portion 36 of the terminal fitting 30 according to the embodiment.

Specifically, the partially overlapping portion 236 is formed by punching out a portion of a core wire crimping portion 232 in such a manner as to leave one side that extends along the circumferential direction of the terminal fitting 230 (here, the three edge portions in the rectangular area of the core wire crimping portion 232 are punched out), and by bending and deforming the punched out portion with the remaining one side as a fold.

Even in the case where the terminal fitting 230 is crimped to the core wire exposed portions, the portion where the partially overlapping portion 236 is present can be a high compression portion compared with the portion where the partially overlapping portion 236 is not present. Also, the terminal fitting 230 can be manufactured from one metal plate material. Furthermore, even in the case where both the core wire crimping portion 232 and the partially overlapping portion 236 are provided on one metal plate material, an increase in the amount of the metal plate material used can be suppressed.

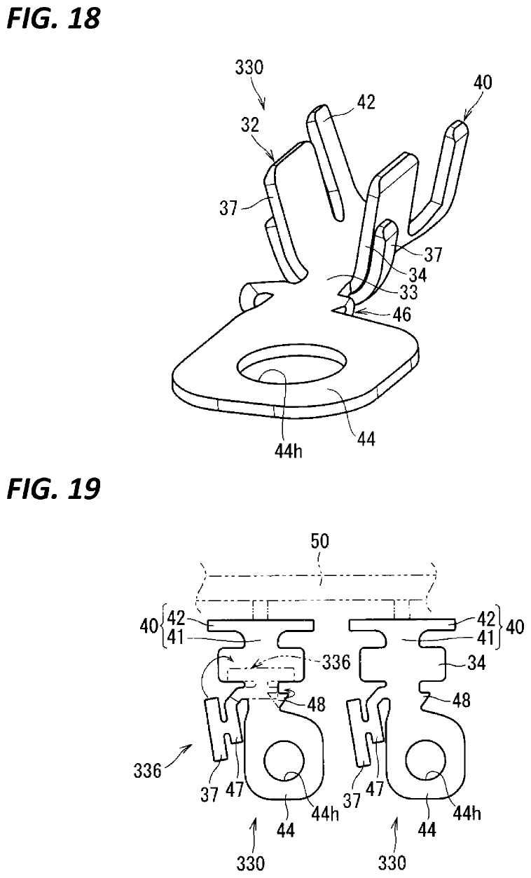

FIG. 18 is a perspective view showing a third variation of the terminal fitting 30 according to the embodiment. FIG. 19 is a developed view of a terminal fitting 330 according to the third variation.

A terminal fitting 330 according to the third variation is different from the terminal fitting 30 according to the embodiment in that the terminal fitting 330 is provided with a mating connection portion 44.

In the terminal fitting 330 according to the third variation, a through hole 44h for screw fastening is formed as the mating connection portion 44. The mating connection portion 44 may be formed in a so-called male terminal shape or female terminal shape.

If the mating connection portion 44 is provided, the mating connection portion 44 is typically provided in such a manner as to extend from the bottom portion 33 of the core wire crimping portion 32. For this reason, it is difficult to provide the partially overlapping portion 36 according to the above embodiment, which is provided in such a manner as to extend from the bottom portion 33, as well as the mating connection portion 44. Accordingly, here, in the portion extending from the bottom portion 33, a partially overlapping portion 336 is provided in such a manner as to protrude laterally from an intermediate portion of a portion of the bottom portion 33 extending to the mating connection portion 44. Then, the high compression piece 37 is overlaid on the outside of the core wire crimping portion 32 by bending the partially overlapping portion 336 along an oblique fold.

The terminal fitting 330 is provided with a locking portion 46 for maintaining the overlapping state of the partially overlapping portion 336. The locking portion 46 is interposed between the high compression piece 37 and the bottom portion 33, and includes a first locking piece 47 that is bent together with the high compression piece 37, and a second locking piece 48 that protrudes to the opposite side of the first locking piece 47 with respect to the bottom portion 33 and is bent and deformed to hold the first locking piece 47.

Also, in the example shown in FIG. 18, the terminal fitting 330 is provided with a coating crimping portion 40. The coating crimping portion 40 includes, for example, a bottom portion 41 extending from the bottom portion 33, and a pair of crimping pieces 42 respectively standing upright on the bottom portion 41. However, the coating crimping portion 40 may not be provided.

### Other Variations

Although the partially overlapping portion 36 has been described as being formed by bending and deforming a part of the plate material constituting the core wire crimping portion 32, this is not an essential configuration. For example, the partially overlapping portion 36 may be provided by changing the thickness dimension of a part of the plate material constituting the core wire crimping portion 32. Also, for example, the partially overlapping portion 36 may be provided separately from the plate material constituting the core wire crimping portion 32. If the partially overlapping portion 36 is provided separately from the plate material constituting the core wire crimping portion 32, a conventional core wire crimping portion can be used as the core wire crimping portion 32.

Although it has been described that the partially overlapping portion 36 is left in the terminal-equipped electrical wire 10, this is not an essential configuration. It is also conceivable that the partially overlapping portion 36 is not left in the terminal-equipped electrical wire 10 after the terminal fitting 30 is crimped. In this case, a groove-shaped recessed portion remains on the outside of the protruding portion on the inside of the core wire crimping portion 32 of the terminal fitting 30. In this case, it is conceivable to provide a protruding portion, which protrudes on the terminal fitting 30 side, in the crimping die. That is, the protruding portion functions as the partially overlapping portion 36 at the time of crimping.

Although the partially overlapping portion 36 has been described as being overlaid on the core wire crimping portion 32 in a double layer manner, this is not an essential configuration. It is also conceivable that the partially overlapping portion 36 overlaps with the core wire crimping portion 32 in a three or more layers manner.

The constituent elements described in the embodiment and the variation given above may be combined as appropriate unless there is no mutual contradiction.

Up to here, the present invention has been described in detail, but the description given above merely illustrates examples in all aspects, and thus the present invention is not limited thereto. It is to be understood that a number of variations that are not described herein are also encompassed within the scope of the present invention without departing from the scope of the present invention.

### LIST OF REFERENCE NUMERALS

10 Terminal-equipped electrical wire

20 Electrical wire

22 Core wire

24 Insulating coating

30 Terminal fitting

32 Core wire crimping portion

33 Bottom portion

34 Core wire crimping piece

36 Partially overlapping portion

37 High compression piece

38 Connection piece

1. A method of manufacturing a terminal-equipped electrical wire comprising the steps of:
(a) preparing a terminal fitting including a core wire crimping portion having a bottom portion and a pair of crimping pieces standing upright on the bottom portion, and a partially overlapping portion overlaid, so as to protrude, on the outside of a partial region of the bottom portion of the core wire crimping portion along an extending direction of the bottom portion;
(b) accommodating core wire exposed portions of electrical wires in the core wire crimping portion; and
(c) crimping the core wire crimping portion to the core wire exposed portions.

2. The method of manufacturing the terminal-equipped electrical wire according to claim 1,
wherein in the step (b), the core wire exposed portion of a first electrical wire and the core wire exposed portion of a second electrical wire are accommodated in the same core wire crimping portion.

3. The method of manufacturing the terminal-equipped electrical wire according to claim 1,
wherein the partially overlapping portion is formed by bending a part of a plate material constituting the core wire crimping portion.

4. A terminal-equipped electrical wire comprising:
electrical wires that each include a core wire and an insulating coating covering the core wire, and in which a core wire exposed portion where the core wire is exposed is formed in a partial region along the longitudinal direction; and
a terminal fitting that includes a core wire crimping portion having a bottom portion and a pair of crimping pieces standing upright on the bottom portion, and crimped to the core wire exposed portions, and a partially overlapping portion overlaid on the outside of a partial region of the bottom portion of the core wire crimping portion along the extending direction of the bottom portion, and in which a portion of the core wire crimping portion that overlaps the partially overlapping portion protrudes to a core wire exposed portions side.

5. The terminal-equipped electrical wire according to claim 4,
wherein the same terminal fitting is crimped to a region in which the core wire exposed portion of a first electrical wire and the core wire exposed portion of a second electrical wire overlap.

6. The terminal-equipped electrical wire according to claim 4,
wherein the partially overlapping portion is formed by bending a part of a plate material constituting the core wire crimping portion.

7. The method of manufacturing the terminal-equipped electrical wire according to claim 2,
wherein the partially overlapping portion is formed by bending a part of a plate material constituting the core wire crimping portion.

8. The terminal-equipped electrical wire according to claim 5,
wherein the partially overlapping portion is formed by bending a part of a plate material constituting the core wire crimping portion.
